(19) United States
(12) Patent Application Publication
(10) Pub. No.: US 2003/0139314 A1
(43) Pub. Date: Jul. 24, 2003

(54) Fabric conditioning compositions

(75) Inventors: Helene Sylvie Buron, Toulouse (FR); Laurent Soubiran, Bebington (GB)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/323,408

(22) Filed: Dec. 19, 2002

(30) Foreign Application Priority Data
Dec. 20, 2001 (GB) 0130556.4

(51) Int. Cl. C11D 1/00

(52) U.S. Cl. 510/329; 510/330; 510/515; 510/504

(57) ABSTRACT

An aqueous fabric conditioning composition in the form of an emulsion comprises one or more quaternary ammonium fabric softening materials, one or more oils and an effective amount of a refractive index increasing agent or decreasing agent to provide a composition where the aqueous phase and the oil phase have refractive indices within +/−2% of each other.

### FIELD OF THE INVENTION

The present invention relates to fabric conditioning compositions, and in particular, relates to clear or translucent fabric softening compositions.

### BACKGROUND OF THE INVENTION

Rinse added fabric conditioning compositions are well known. Typically, such compositions comprise a fabric softening agent dispersed in water. The fabric softening agent can be included at up to 8% by weight, in which case the compositions are considered dilute, or at levels from 8% to 60% by weight, in which case the compositions are considered concentrated.

Typically fabric conditioners are either lamellar dispersions of the cationic surfactant or are in the form of emulsions. In either case, they are conventionally opaque, thick liquids.

Clear or translucent fabric softening compositions are also desirable to consumers.

It has been suggested in WO 01/04254 (Unilever) to provide a clear or translucent fabric conditioning composition. The composition is concentrated and achieves clarity/translucence using high levels of solvent to provide a water-in-oil micro-emulsion.

Microemulsions are thermodynamically stable, isotropic systems which are inherently clear. However, they typically require specific materials present at particular ratios to satisfy a correct microstructure allowing the microemulsion to be formed.

It is therefore desirable to provide an alternative to microemulsions.

Surprisingly, it has now been found that a clear or translucent composition can be provided in the form of a macroemulsion.

### SUMMARY OF THE INVENTION

Thus, according to the present invention there is provided an aqueous fabric conditioning composition comprising:

(i) one or more quaternary ammonium fabric softening materials,

(ii) one or more oils,

(iii) a refractive index increasing agent the composition being in the form of an emulsion comprising an aqueous phase and an oil phase, the refractive index increasing agent being present in an effective amount to provide an aqueous phase with a refractive index +/−2% of the refractive index of the oil phase.

The invention further provides an aqueous fabric conditioning composition comprising:

(i) one or more quaternary ammonium fabric softening materials,

(ii) one or more oils,

(iii) a refractive index decreasing agent the composition being in the form of an emulsion comprising an aqueous phase and an oil phase, the refractive index decreasing agent being present in an effective amount to provide an oil phase with a refractive index +/−2% of the refractive index of the aqueous phase.

According to the invention, there is also provided a process for conditioning fabrics comprising the step of contacting the fabric conditioning composition of the invention with fabrics in a laundry treatment process.

### DETAILED DESCRIPTION OF THE INVENTION

The present invention is particularly concerned with cationic fabric softening compositions which comprise macroemulsions and are clear or at least translucent. In the context of the present invention, “clear or translucent” is defined as a direct transmittance of 80% or more. Direct Transmittance is calculated using a sample contained within a 1 cm square disposable PMMA or glass cuvette. Percentage transmittance measurements are made using a Perkin Elmer Lambda 40 UV-Vis Spectrometer at a wavelength of 589 nm and a slit size of 2 nm. A reduction in light transmittance of 0 to 20% is within the scope of the invention as the product is still considered translucent. Where the reduction is 10% or less, the product is considered to be clear. Thus it is highly desirable that the percentage transmittance is 90% or more.

The term ‘macroemulsion’ or ‘emulsion’ means a liquid product at ambient temperature which is metastable, comprises droplets, or groups of droplets, of one immiscible liquid suspended in another liquid and which shows none of the signatures of a lamellar phase dispersion as evaluated by low angle x-ray diffraction and polarising light microscopy.

It does not include conventional micro-emulsions which are thermodynamically stable across a specified temperature range.

Furthermore, it does not include conventional fabric conditioning compositions which consist entirely of aqueous lamellar phase dispersions. Aqueous lamellar phase dispersions consist of a suspension of a lamellar liquid crystalline phase in a liquid, in which the molecular packing of the suspended material results in a structure which exhibits long range order.

The compositions of the present invention may comprise a mixture of emulsion droplets and dispersions. These compositions are entirely different from conventional aqueous lamellar dispersions which are free of an emulsion component. For instance, unlike pure dispersions, mixed emulsion/dispersion compositions do not necessarily exhibit long range order.

In the context of the present invention, “long range order” means positional and orientational order of the structure in at least one direction. For an explanation of positional and orientational order, see “Introduction to Liquid Crystals”, Chemistry and Physics, P. J. Collings and M Hird, printed 1997, reprinted 1998, p1.

Long range order can be verified by detection of Bragg peaks using low angle x-ray diffraction or by observing the composition in a polarising light microscope.

Generally the compositions of the present invention will comprise an oily phase comprising one or more oils and one or more ingredients soluble in oil and an aqueous phase comprising water and one or more ingredients soluble in water. The quaternary ammonium fabric softening materials is dispersed in the form of lamellar particles throughout the aqueous phase.

Matching Refractive Indices

The aqueous phase and the oil phase have refractive indices within +/−2% of each other. In practise, it is found that differences of 1 to 2% products will provide products which are translucent, as defined above, and differences of less than 1% provide clear products, as defined above. Thus it is highly desirable that the difference in the refractive indices of the oil phase and aqueous phase is less than 1%. In the present invention, all refractive index measurements are carried out using a digital refractometer (RFM340, Bellingham & Stanley) connected to a Grant LTD 6G waterbath. Sodium yellow light (589.3 nm) is used and measurements are made at a temperature of 20° C. and at a pressure of 1 bar.

Quaternary Ammonium Fabric Softening Material

The fabric conditioning composition of the present invention comprises one or more quaternary ammonium materials.

These surfactants are fabric softening materials which are typically included in rinse-added fabric softening compositions.

The material generally comprises one or more fatty hydrocarbyl chains.

Preferably, the average chain length of the alkyl or alkenyl group is at least C₁₄, more preferably at least C₁₆. Most preferably at least half of the chains have a length of C₁₈. It is generally preferred if the alkyl or alkenyl chains are predominantly linear.

It is especially preferred if the softening material is a water insoluble quaternary ammonium material which comprises a compound having two C₁₂₋₁₈ alkyl or alkenyl groups connected to the nitrogen head group via at least one ester link. It is more preferred if the quaternary ammonium material has two ester links present.

A first group of preferred ester-linked cationic surfactant materials for use in the invention is represented by formula (I):

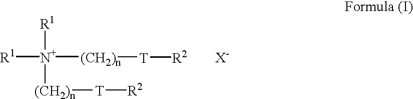

wherein each R¹ group is independently selected from C₁₋₄ alkyl or C₂₋₄ alkenyl groups; and wherein each R² group is independently selected from C₈₋₂₈ alkyl or alkenyl groups;

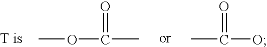

X⁻ is any anion compatible with the cationic surfactant, such as halides or alkyl sulphates, e.g. chloride, methyl sulphate or ethyl sulphate and n is 0 or an integer from 1-5.

A preferred material within this formula is N-N-di(tallowoyloxy ethyl) N,N-dimethyl ammonium chloride.

A second preferred softening material for use in the invention is represented by formula (II):

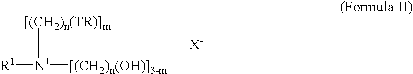

wherein each R is independently selected from a C₅₋₃₅ alkyl or alkenyl group, R¹ represents a C₁₋₄ alkyl or hydroxyalkyl group or a C₂₋₄ alkenyl group, m is 1, 2 or 3 and denotes the number of moieties to which it refers that pend directly from the N atom and T, n and X⁻ are as defined above.

Especially preferred materials within this formula are di-alkenyl esters of triethanol ammonium methyl sulphate. Commercial examples of compounds within this formula are Tetranyl® AOT-1 (di-oleic ester of triethanol ammonium methyl sulphate 80% active), AO-1(di-oleic ester of triethanol ammonium methyl sulphate 90% active), Tetranyl® AHT-1 (di-hardened tallowyl ester of triethanol ammonium methyl sulphate 85% active), L1/90 (partially hardened tallow ester of triethanol ammonium methyl sulphate 90% active), L5/90 (palm ester of triethanol ammonium methyl sulphate 90% active (supplied by Kao corporation); Rewoquat WE15 (C₁₀-C₂₀ and C₁₆-C₁₈ unsaturated fatty acid reaction products with triethanolamine dimethyl sulphate quaternised 90% active), WE18 and WE20 (both are partially hardened tallow ester of triethanol ammonium methyl sulphate 90% active), ex Goldschmidt Corporation; and Stepantex VK-90 (partially hardened tallow ester of triethanol ammonium methyl sulphate 90% active), ex Stepan Company.

A third preferred type of quaternary ammonium material is represented by formula (III):

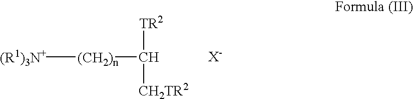

wherein R¹, R², n, T and X⁻ are as defined above.

Preferred materials of this class such as 1,2 bis[tallowoyloxy]-3-trimethylammonium propane chloride and 1,2-bis[oleyloxy]-3-trimethylammonium propane chloride and their method of preparation are, for example, described in U.S. Pat. No. 4,137,180 (Lever Brothers), the contents of which are incorporated herein. Preferably these materials also comprise small amounts of the corresponding monoester, as described in U.S. Pat. No. 4,137,180.

A fourth preferred type of quaternary ammonium material is represented by formula (IV):

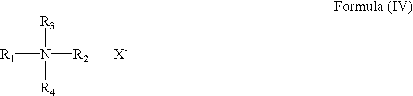

where R₁ and R₂ are C₈₋₂₈ alkyl or alkenyl groups; R₃ and R₄ are C₁₋₄ alkyl or C₂₋₄ alkenyl groups and X⁻ is as defined above.

Examples of compounds within this formula include di(tallow alkyl)dimethyl ammonium chloride, di(tallow alkyl) dimethyl ammonium methyl sulphate, dihexadecyl dimethyl ammonium chloride, di(hardened tallow alkyl) dimethyl ammonium chloride, dioctadecyl dimethyl ammonium chloride and di(coconut alkyl) dimethyl ammonium chloride.

The softening material is preferably present in an amount from 2 to 60% by weight of the active ingredient, more preferably 2.5 to 30% by weight, most preferably 3-25% by weight, based on the total weight of the composition.

Preferred quaternary ammonium fabric softening materials are substantially water insoluble.

‘Substantially water insoluble’ surfactant materials in the context of this invention are defined as materials having a solubility less than 1×10⁻³ wt % in demineralised water at 20° C. Preferably the cationic surfactants have a solubility less than 1×10⁻⁴. Most preferably the cationic surfactants have a solubility at 20° C. in demineralised water from 1×10⁻⁸ to 1×10⁻⁶ wt %.

Iodine Value of the Softening Material

The total average iodine value, which is based on the iodine value of the parent fatty acid from which R¹ is formed, is from preferably from 0 to 140, more preferably from about 0 to 130, most preferably from about 0 to 100, e.g. 0 to 40 or even 0 to 35. For better softening results, it is desirable to use a softening material whose parent fatty acid has an iodine value of 0 to 5, most desirable 0 to 2.

Calculation of Iodine Value

In the context of the present invention, iodine value of the parent fatty acid of the cationic surfactant is defined as the number of grams of iodine which react with 100 grams of compound.

Oils

The compositions of the present invention comprise at least one oil. The oil may be a mineral oil, an ester oil and/or natural oils such as vegetable oils. However, ester oils or mineral oils are preferred.

The ester oils are preferably hydrophobic in nature such that they are substantially insoluble in the aqueous phase. They include fatty esters of mono or polyhydric alcohols having from 1 to 24 carbon atoms in the hydrocarbon chain, and mono or polycarboxylic acids having from 1 to 24 carbon atoms in the hydrocarbon chain, provided that the total number of carbon atoms in the ester oil is equal to or greater than 16, and that at least one of the hydrocarbon chains has 12 or more carbon atoms.

Suitable ester oils include saturated ester oils, such as the PRIOLUBES (ex Unichema). 2-ethyl hexyl stearate (PRIOLUBE 1545), neopentyl glycol monomerate (PRIOLUBE 2045) and methyl laurate (PRIOLUBE 1415) are particularly preferred although oleic monoglyceride (PRIOLUBE 1407) and neopentyl glycol dioleate (PRIOLUBE 1446) are also suitable.

It is preferred that the viscosity of the ester oil is from 0.002 to 0.4 Pa.S (2 to 400 cps) at a temperature of 25° C. at 106 s⁻¹, measured using a Haake rotoviscometer, and that the density of the mineral oil is from 0.8 to 0.9 g.cm⁻³ at 25° C.

Suitable mineral oils include branched or straight chain hydrocarbons (e.g. paraffins) having 8 to 35, more preferably 9 to 20 carbon atoms in the hydrocarbon chain.

Preferred mineral oils include the Marcol technical range of oils (ex Esso) although particularly preferred is the Sirius range (ex Silkolene) or Semtol (ex Witco Corp.). The molecular weight of the mineral oil is typically within the range 100 to 400.

One or more oils of any of the above mentioned types may be used.

Typically the oil has a refractive index, as measured using the apparatus and measuring conditions referred to above, of from about 1.4 to about 1.5. For instance the refractive indices of various suitable commercially available sources of oil are given below (the refractive index is given in brackets after the name of the oil):

Isoparafina (1.423), M40 Sirius (1.453), M85 Sirius(1.491), Semtol 70/28(1.469), Estasol (1.424), Sunflower oil (1.476), DC 556 (1.461), Estol 1502 (1.432), Isopar G (1.419) and Isopar V (1.454).

The oil may be present in an amount from 1-30% by weight, more preferably 2-25%, by weight most preferably 3-20%, e.g. 4-15% by weight, based on the total weight of the composition.

Preferably, the weight ratio of quaternary ammonium softener to oil in the composition is in the range 5:1 to 1:10, more preferably 4:1 to 1:5, most preferably 3:1 to 1:3.

The weight ratio of 3:1 to 1:3 is particularly desirable as, when a perfume is present in the compositions, the ratio provides the added benefit of increased perfume delivery to fabrics and improved perfume substantivity upon storage of dried fabrics.

The oil referred to herein, is preferably added to the composition as a separate component, that is, in addition to any oil which may be present in other components of the composition.

Refractive Index Increasing Agent

In one embodiment, an effective amount of an agent is present which increases the refractive index of the aqueous phase to match that of the oil phase.

In order to perform the function of increasing the refractive index of the aqueous phase, the agent is selected on the basis that it has a higher refractive index than water (the refractive index of water is measured as 1.33) and is substantially soluble therein at 20° C.

Thus, it is preferred that the refractive index increasing agent is hydrophilic.

Suitably hydrophilic compounds generally have a ClogP of less than 3.0 more preferably less than 2.5 even more preferably less than 2.0.

In the context of the present invention, ClogP is calculated according to ClogP p.c. program version 3.06, available from Daylight Chemical Information Systems.

Suitable refractive index increasing agents include:

Salts

Preferred salts include alkali metal and alkaline earth metal salts, e.g. chlorides, sulphates and nitrates of sodium, potassium, calcium and magnesium.

Carbohydrates

Examples of suitable carbohydrates include fructose, sucrose, glucose, sorbitol and combinations thereof.

Organic Carboxylic Acids

Examples of suitable carboxylic acids include gluconic, acetic, citric, lactic and propionic acids.

Alcohols

Suitable alcohols include low molecular weight (e.g. having a molecular weight less than 180) mono alcohols such as C1 to C8 straight chain alcohols, diols such as ethanediol, polyols such as glycerol, and aromatic alcohols such as benzyl alcohol.

Aldehyde and Ketones

Preferred aldehydes include low molecular weight (e.g. having a molecular weight less than 180) compounds such as ethanal, propanal, butanal, pentanal and benzaldehyde. Preferred ketones include acetone and benzophenone.

One or more refractive index increasing agents may be present in the composition.

The refractive index increasing agent is preferably present in an amount from 0.3 to 50% by weight, more preferably 0.4 to 25% by weight, most preferably 0.5 to 10% by weight based on the total weight of the composition.

Refractive Index Decreasing Agent

In another embodiment, an effective amount of an agent is present which decreases the refractive index of the oil phase to match that of the aqueous phase.

The refractive index decreasing agents are selected on the basis that they have a lower refractive index than the oil.

Since suitable oils generally have a refractive index of from about 1.4 to about 1.5, it is preferred that the refractive index reducing agent has a refractive index water of less than about 1.4.

The refractive index reducing agent should also be soluble in the oil. Thus the refractive index reducing agent should preferably be hydrophobic.

Suitably hydrophobic compounds generally have a ClogP of 3.0 or more, more preferably 4.0 or more, most preferably 5.0 or more.

Suitable refractive index decreasing agents include high molecular weight alcohols (preferably having a molecular weight greater than 180), secondary amines such as dimethylamine (R.I. of 1.37), linear chloroalkanes such as 2-chlorobutane (R.I. of 1.39), fluoroalcohols such as 1,3-difluoro-2-propanol (R.I. of 1.371), fluoronated monomers such as dodecafluoroheptyl methacrylate (R.I. of 1.349) and nitro alkanes such as nitromethane (R.I. of 1.38).

One or more refractive index decreasing agents may be present in the composition.

The refractive index decreasing agent is preferably present in an amount from 0.05% to 30% by weight, more preferably from 0.1% to 25% by weight, most preferably from 0.15% to 15% by weight, based on the total weight of the composition.

It is possible that a refractive index increasing agent which is soluble in water at 20° C. is also partly soluble in oil. In such a case, it is preferred that the agent has a refractive index between that of water and the oil and thus can act as both a refractive index increasing and decreasing agent.

It is also within the scope of the invention to provide a composition comprising both a refractive index increasing agent for the aqueous phase and separate refractive index decreasing agent for the oil phase.

Water

The compositions of the invention are aqueous. That is they comprise an aqueous phase.

Typically, the level of water present is from 35-95% by weight, more preferably 50-93% by weight, even more preferably 65-92% by weight, most preferably 70-90% by weight, based on the total weight of the composition.

Nonionic Surfactant

It is preferred that the compositions further comprise a nonionic surfactant. Typically these can be included for the purpose of stabilising the compositions.

It has also been found that the nonionic surfactant can increase the refractive index of the aqueous phase.

This is particularly surprising since refractive index increasing agents described above are required to be soluble in the aqueous phase in order to increase refractive index of the aqueous phase whereas the nonionic surfactant is not necessarily soluble in the aqueous phase.

Suitable nonionic surfactants include addition products of ethylene oxide and/or propylene oxide with fatty alcohols, fatty acids and fatty amines.

Any of the alkoxylated materials of the particular type described hereinafter can be used as the nonionic surfactant.

Suitable surfactants are substantially water soluble surfactants of the general formula:

R—Y—(C₂H₄O)_{z}—C₂H₄OH

where R is selected from the group consisting of primary, secondary and branched chain alkyl and/or acyl hydrocarbyl groups; primary, secondary and branched chain alkenyl hydrocarbyl groups; and primary, secondary and branched chain alkenyl-substituted phenolic hydrocarbyl groups; the hydrocarbyl groups having a chain length of from 8 to about 25, preferably 10 to 20, e.g. 14 to 18 carbon atoms.

In the general formula for the ethoxylated nonionic surfactant, Y is typically:

—O—, —C(O)O—, —C(O)N(R)— or —C(O)N(R)R—

in which R has the meaning given above or can be hydrogen; and Z is at least about 8, preferably at least about 10 or 11.

Z represents the average degree of alkoxylation of the nonionic surfactant.

Preferably the nonionic surfactant has an HLB of from about 7 to about 20, more preferably from 10 to 18, e.g. 12 to 16.

Examples of nonionic surfactants follow. In the examples, the integer defines the number of ethoxy (EO) groups in the molecule.

A. Straight-Chain, Primary Alcohol Alkoxylates

The deca-, undeca-, dodeca-, tetradeca-, and pentadecaethoxylates of n-hexadecanol, and n-octadecanol having an HLB within the range recited herein are useful viscosity/dispersibility modifiers in the context of this invention. Exemplary ethoxylated primary alcohols useful herein as the viscosity/dispersibility modifiers of the compositions are C₁₈ EO(10); and C₁₈ EO(11). The ethoxylates of mixed natural or synthetic alcohols in the “tallow” chain length range are also useful herein. Specific examples of such materials include tallow alcohol-EO(11), tallow alcohol-EO(18), and tallow alcohol-EO (25), coco alcohol-EO(10), coco alcohol-EO(15), coco alcohol-EO(20) and coco alcohol-EO(25).

B. Straight-Chain, Secondary Alcohol Alkoxylates

The deca-, undeca-, dodeca-, tetradeca-, pentadeca-, octadeca-, and nonadeca-ethoxylates of 3-hexadecanol, 2-octadecanol, 4-eicosanol, and 5-eicosanol having an HLB within the range recited herein are useful viscosity and/or dispersibility modifiers in the context of this invention. Exemplary ethoxylated secondary alcohols useful herein as the viscosity and/or dispersibility modifiers of the compositions are: C₁₆ EO(11); C₂₀ EO(11); and C₁₆ EO(14).

C. Alkyl Phenol Alkoxylates

As in the case of the alcohol alkoxylates, the hexa- to octadeca-ethoxylates of alkylated phenols, particularly monohydric alkylphenols, having an HLB within the range recited herein are useful as the viscosity and/or dispersibility modifiers of the instant compositions. The hexa- to octadeca-ethoxylates of p-tri-decylphenol, m-pentadecylphenol, and the like, are useful herein. Exemplary ethoxylated alkylphenols useful as the viscosity and/or dispersibility modifiers of the mixtures herein are: p-tridecylphenol EO(11) and p-pentadecylphenol EO(18).

As used herein and as generally recognized in the art, a phenylene group in the nonionic formula is the equivalent of an alkylene group containing from 2 to 4 carbon atoms. For present purposes, nonionics containing a phenylene group are considered to contain an equivalent number of carbon atoms calculated as the sum of the carbon atoms in the alkyl group plus about 3.3 carbon atoms for each phenylene group.

D. Olefinic Alkoxylates

The alkenyl alcohols, both primary and secondary, and alkenyl phenols corresponding to those disclosed immediately hereinabove can be ethoxylated to an HLB within the range recited herein and used as the viscosity and/or dispersibility modifiers of the instant compositions.

E. Branched Chain Alkoxylates

Branched chain primary and secondary alcohols which are available from the well-known “OXO” process can be ethoxylated and employed as the viscosity and/or dispersibility modifiers of compositions herein.

F. Polyol Based Surfactants

Suitable polyol based surfactants include sucrose esters such sucrose monooleates, alkyl polyglucosides such as stearyl monoglucosides and stearyl triglucoside and alkyl polyglycerols.

The above nonionic surfactants are useful in the present compositions alone or in combination, and the term “nonionic surfactant” encompasses mixed nonionic surface active agents.

The nonionic surfactant is present in an amount from 0.01 to 10%, more preferably 0.1 to 5%, most preferably 0.35 to 3.5%, e.g. 0.5 to 2% by weight, based on the total weight of the composition.

Anti-Oxidation/Reduction Stabilisers

The compositions of the invention may, optionally, comprise one or more additional stabilisers which stabilise against oxidation and/or reduction.

If the stabilisers are present as anti-oxidants, they may be added at a level of from 0.005 to 2% by weight based on the total weight of the composition, more preferably from 0.01 to 0.2% by weight, most preferably from 0.035% to 0.1% by weight.

If present as an anti-reduction agent, then the stabiliser is preferably used in an amount from 0.001% to 0.2% by weight based on the total weight of the composition.

Perfumes

The compositions of the invention may also comprise one or more perfumes.

When present, the perfume is used in a concentration of preferably from 0.01-15% by weight, more preferably from 0.05-10% by weight, most preferably from 0.1-5% by weight, e.g. 0.15 to 4.5% by weight based on the total weight of the composition.

Other Optional Ingredients

The compositions may also contain one or more optional ingredients conventionally included in fabric conditioning compositions such as pH buffering agents, perfume carriers, fluorescers, colourants, hydrotropes, antifoaming agents, antiredeposition agents, polyelectrolytes, enzymes, optical brightening agents, anti-shrinking agents, anti-wrinkle agents, anti-spotting agents, germicides, fungicides, anti-corrosion agents, drape imparting agents, anti-static agents, ironing aids and dyes.

Preparation

The compositions of the invention may be prepared according to any suitable method.

In a first preferred method, the quaternary ammonium fabric softening material, oil, refractive index increasing and/or decreasing agents and optional nonionic surfactant are heated together to above the melting temperature of the quaternary ammonium fabric softening material to form a melt. In a separate container, water is heated to about 70° C. and the melt is poured into the water under agitation. The resulting mixture is allowed to cool and then optional ingredients such as perfume and dye are added.

Product Form

In its undiluted state at ambient temperature the product is in the form of an aqueous macroemulsion.

The viscosity of the compositions is preferably from 50 to 280 mPa.s at 106 s⁻¹ at 20° C. measured using a Haake Rotoviscometer NV cup and bob.

Product Use

The composition is preferably used in the rinse cycle of a domestic textile laundering operation, where, it may be added directly in an undiluted state to the washing machine, e.g. through a dispenser drawer. Alternatively, it can be diluted prior to use. The compositions may also be used in a domestic hand-washing laundry operation.

Composition pH

When the composition is dispersed in water, the solution preferably has a pH of from 1.5 to 5, more preferably from 2 to 4.5. Compositions with a pH value exceeding 7 are undesirable because it is believed that the cationic softener becomes crystalline and deposits less effectively onto fabrics.

### EXAMPLES

The invention will now be illustrated by the following non-limiting examples. Further modification within the scope of the present invention will be apparent to the person skilled in the art.

Samples according to the invention and comparative examples are denoted by numbers and letters respectively.

All values given in the tables are % by weight of the active ingredient unless otherwise indicated.

The compositions in table 1 were prepared as follows:

The quaternary ammonium cationic softening compound, alcohol, oil and nonionic surfactant were mixed and heated to 60° C. to form a homogeneous premixture. Water was heated to 60° C. in a separate vessel and the premixture was then added to the water and mixed.

All of samples 1 to 3 were tested for clarity and had direct transmittance readings of over 90%; that is they formed clear compositions, as defined herein.

In each case, the difference between the refractive indices of the oil phase and the aqueous phase within the samples was less than 2%.

TABLE 1

| | Sample | | |
|---|---|---|---|
| | 1 | 2 | 3 |
| Oil (1) | 7.5 | 7.5 | 7.5 |
| Nonionic Surfactant (2) | 1 | 1 | 1 |
| Arquad 2HT (3) | 7.5 | | |
| Tetranyl L1/90 (4) | | 7.5 | |
| Rewoquat WE-15 (5) | | | 7.5 |
| Alcohol (6) | 5 | 5 | 5 |
| Aqueous phase (7) | 78.7 | 78.7 | 78.7 |

(1) isoparafina, ex Exxon Mobil Corporation
(2) Genapol C100, C9-12 alcohol 10 EO, ex Clariant
(3) di[hardened tallowyl] dimethylammonium chloride, ex Akzo
(4) partially hardened tallow ester of triethanol ammonium methyl sulphate 90% active, ex Kao
(5) C₁₀-C₂₀ and C₁₆-C₁₈ unsaturated fatty acid reaction products with triethanolamine dimethyl sulphate quaternised 90% active, ex Goldschmidt
(6) isopropyl alcohol
(7) aqueous solution comprising 50 wt % sucrose and 50 wt % water

The compositions were then evaluated for their softening performance and perfume intensity against a premium brand fabric conditioner, dilute Comfort (purchased in Thailand September 2000).

### Example 1

### Softening Evaluation of Cloth Treated in a Tergotometer

The softening performance of freshly prepared compositions was evaluated by adding 0.1 g of the composition to 1 litre of demineralised water at ambient temperature in a Tergotometer to form a rinse liquor. The level of active ingredients in the rinse liquor for the examples of the invention and the comparative examples was the same. Three pieces of terry towelling (20 cm×20 cm) were added to the Tergotometer pot (the towelling having previously been rinsed for 1 minute with 0.001% wt/wt. sodium alkyl benzene sulphonate to simulate carry-over of anionic detergent from the main wash). The cloths were rinsed for five minutes in the Tergotometer pot at 65 rpm, spin dried to remove excess liquor, and line dried overnight.

Softness was evaluated by a trained panel who ranked the cloths against set standards on a scale of 1 to 8 where 1 denotes an exceptionally soft cloth and 8 denotes untreated cloth.

The results are given in table 2.

TABLE 2

| | Sample | | | |
|---|---|---|---|---|
| | 1 | 2 | 3 | Comfort |
| Softness | 5.88 | 4.75 | 5.38 | 4.63 |

The results demonstrate that there is not a significant loss in softening performance when comparing the samples of the invention and the premium brand softener.

### Example 2

### Perfume Evaluation of Cloth Treated in a Tergotometer

Perfume delivery from the compositions was evaluated by rinsing three pieces of terry towelling (20 cm×20 cm) per product in a similar manner to that previously described for softening evaluation of cloth treated in a tergotometer. The composition was added in a sufficient amount to give 0.1 g/L active with a perfume level in the rinse liquor of 4.8 mg/L.

Perfume intensity on the cloth was evaluated by an expert panel who ranked the perfume intensity against set standards. Perfume intensity was based on a comparative numbering system which ranged from 0, denoting undetectable, to 5, denoting exceptionally strong perfume intensity. The results are given in Table 3.

TABLE 3

| | Sample | | | |
|---|---|---|---|---|
| | 1 | 2 | 3 | Comfort |
| Perfume | 1.30 | 1.40 | 1.40 | 0.65 |
| Intensity | | | | |

Thus, the perfume intensity from cloth treated with the compositions according to the invention was significantly greater than that on cloth treated with the comparative composition.

1. An aqueous fabric conditioning composition comprising:
(i) one or more quaternary ammonium fabric softening materials,
(ii) one or more oils,
(iii) a refractive index increasing agent the composition being in the form of an emulsion comprising an aqueous phase and an oil phase, the refractive index increasing agent being present in an effective amount to provide an aqueous phase with a refractive index +/−2% of the refractive index of the oil phase.

2. An aqueous fabric conditioning composition comprising:
(i) one or more quaternary ammonium fabric softening materials,
(ii) one or more oils,
(iii) a refractive index decreasing agent the composition being in the form of an emulsion comprising an aqueous phase and an oil phase, the refractive index decreasing agent being present in an effective amount to provide an oil phase with a refractive index +/−2% of the refractive index of the aqueous phase.

3. A fabric conditioning composition according either of claims 1 or 2 wherein the quaternary ammonium fabric softening material is represented by the formula: 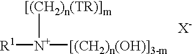
wherein each R is independently selected from a C₅₋₃₅ alkyl or alkenyl group, R¹ represents a C₁₋₄ alkyl or hydroxyalkyl group or a C₂₋₄ alkenyl group, m is 1, 2 or 3 and denotes the number of moieties to which it refers that pend directly from the N atom; 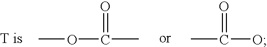
X⁻ is any anion compatible with the cationic surfactant, such as halides or alkyl sulphates, e.g. chloride, methyl sulphate or ethyl sulphate and n is 0 or an integer from 1-5.

4. A fabric conditioning composition according to claim 1 wherein the refractive index increasing agent has a ClogP of less than 3.

5. A fabric conditioning composition according to claim 2 wherein the refractive index decreasing agent has a ClogP of 3 or more.

6. A fabric conditioning composition according to claim 1 further comprising a nonionic surfactant.

7. A fabric conditioning composition according to claim 1 wherein the oil is a mineral oil.

8. A fabric conditioning composition according to claim 1 wherein the composition is clear or translucent.

9. A fabric conditioning composition according to claim 2 further comprising a nonionic surfactant.

10. A fabric conditioning composition according to claim 2 wherein the oil is a mineral oil.

11. A fabric conditioning composition according to claim 2 wherein the composition is clear or translucent.

12. A process for conditioning fabrics comprising the step of contacting the fabric conditioning composition according to claim 1 with fabrics in a laundry treatment process.

13. A process for conditioning fabrics comprising the step of contacting the fabric conditioning composition according to claim 2 with fabrics in a laundry treatment process.
